(19) United States
(12) Patent Application Publication
(10) Pub. No.: US 2002/0075590 A1
(43) Pub. Date: Jun. 20, 2002

(54) Filter Construction, method of making, and method of use

(76) Inventors: Vijay Kumar Garikipati, Eagan, MN (US); Randy Logan, Farmington, MN (US); Daniel L. Tuma, St. Paul, MN (US)

Correspondence Address: MERCHANT & GOULD PC, P.O. BOX 2903, MINNEAPOLIS, MN, 55402-0903, US

(21) Appl. No.: 09/737,264

(22) Filed: Dec. 14, 2000

(51) Int. Cl. G11B 17/02

(52) U.S. Cl. 360/97.02

(57) ABSTRACT

A filter construction for use in a disk drive enclosure. The filter construction includes a first filter portion that removes or reduces contaminants entering the disk drive enclosure; the filter construction further includes a second filter portion that removes or reduces contaminants present within the disk drive enclosure. In one embodiment, the first filter portion has an adsorbent filter, such as a breather filter, positioned over the disk drive port that extends from the enclosure to the exterior of the enclosure. A diffusion channel can be combined with the adsorbent filter. The second filter portion includes an adsorbent filter, such as a recirculation filter, which allows air or gas to flow through with little resistance.

### FIELD OF THE INVENTION

The present invention relates to a filter construction and to a method for making a filter construction. More particularly, the filter construction combines the advantages of a recirculation filter in a hard disk drive enclosure and a breather filter.

### BACKGROUND OF THE INVENTION

Hard disk drives are enclosures in which an inflexible platter coated with magnetic material is spun very rapidly. A magnetic read/write head “flies” only a few microns above the disk on an air cushion. To provide a hard disk drive having high efficiency, it is desirable to position the head as close to the disk as possible without touching it.

It has been found that particulate and gaseous contaminants act to reduce efficiency and longevity of hard disk drives. Common sources of contaminants in disk drives include leaks (which may or may not be intentional), the manufacturing environment, and the materials incorporated into the disk drive which give off particulates and gases. It is of particular concern that acidic and organic vapors can be generated inside disk drive enclosures during normal operating conditions when, for example, the temperature exceeds 150° F. (about 65° C.). Such temperatures can be achieved by simply leaving the computer in the trunk of a car on a hot day.

Recirculation filters have been used in hard disk drives for removing particulate contaminates. They are not, however, suitable for removing acidic or organic vapors since they do not have a capacity for permanently adsorbing organic vapors. To provide enhanced chemical vapor removal, it has been proposed to include activated carbon in recirculation filters. Activated carbon in the form of granules or fibers can adsorb chemical vapors. However, permeability of the filters is sacrificed, which results in lower particulate effectiveness of the filter.

Improvements in recirculation filter designs are desired.

### SUMMARY OF THE INVENTION

The present invention is to a filter construction for placement within a disk drive enclosure. The filter construction reduces the number of contaminants present within the disk drive enclosure, and also reduces, preferably eliminates, any contaminants entering the enclosure through a vent port in the enclosure. The filter construction can be configured to remove physical contaminants, e.g., particulates, from either or both of the air within the enclosure and the air entering the enclosure. Alternately or additionally, the filter construction can be configured to remove chemical contaminants, such as acids or bases, from either or both of the air within the enclosure and the air entering the enclosure.

Specifically, the present invention is to a filter construction comprising a housing; a first filter portion in the housing, and a second filter portion in the housing. The first filter portion is configured and arranged for positioning in an incoming air stream to provide a path for flow of air into the disk drive enclosure, the incoming air stream entering the disk drive enclosure through a port. The second filter portion is configured and arranged for positioning in an air current to provide a path for flow of air within the disk drive enclosure.

The present invention is also directed to a disk drive assembly having a filter construction therein. Such a disk drive assembly comprises an enclosure, a disk rotatably mounted within the enclosure, and a filter construction. The filter construction, which is positioned within the enclosure, comprises: a housing positioned in an air current, the air current moving within the disk drive enclosure; a first filter portion in the housing; and a second filter portion in the housing.

A method or removing contaminants from a disk drive assembly is also disclosed. The method including positioning a filter construction at least partially within a disk drive assembly, with the filter construction comprising a first filter portion, and a second filter portion. The method further includes filtering an incoming air stream with the first filter portion, the incoming air stream entering the disk drive assembly through a port; and filtering an internal air current with the second filter portion, the internal air current moving within the disk drive assembly.

### BRIEF DESCRIPTION OF THE DRAWINGS

FIG. 1 is a schematic top view of a portion of a hard disk drive containing a filter construction according to the present invention;

FIG. 2 is an exploded view of a first embodiment of a filter construction according to the present invention;

FIG. 3 is an exploded view of a second embodiment of a filter construction according to the present invention;

FIG. 4 is a top perspective view of the filter construction of FIG. 3;

FIG. 5 is a bottom view of the filter construction of FIGS. 3 and 4; and

FIG. 6 is a partial cross-sectional side view of a second portion of a filter construction according to the present invention.

### DETAILED DESCRIPTION OF THE PREFERRED EMBODIMENTS

The preferred embodiment of the invention is now described in detail with reference to the drawings, wherein like reference numerals represent like parts and assemblies throughout the several views.

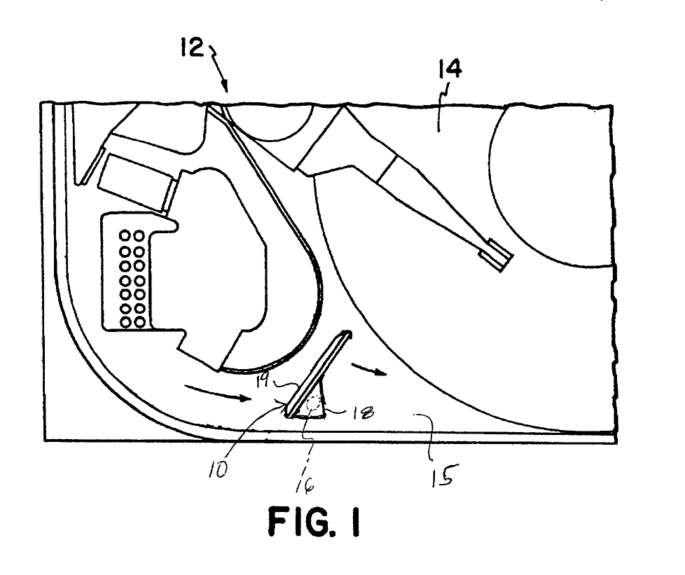

Referring to FIG. 1, a filter construction according to the present invention is depicted at reference numeral 10. Filter construction 10 is shown positioned in close proximity to a hard disk 14 within a hard disk drive enclosure 12. Although filter construction 10 is shown in use inside a hard disk drive enclosure 12, the filter construction 10 can be used in numerous types of electronic equipment, for example, computers, video cameras, digital cameras, compact disc (CD) players, DVD players, and the like. The filter construction 10 can also be used with other electronic equipment and/or in other applications.

It should be appreciated that in the context of this invention the reference to the “reduction” or “removal” of contaminants refers to the clarification of a fluid stream (e.g., gas or liquid stream) being filtered. The stream being clarified in a hard disk drive enclosure is typically an air stream. It should be appreciated, however, that streams of other gases or liquids could also be clarified by the filter construction of the present invention. The reduction or removal of contaminants from a liquid or gas stream by a filter construction can also be referred to as entrapment, immobilization, adsorption, absorption, or otherwise binding (e.g., by physical, covalent, ionic, coordinative, hydrogen, or Van der Waals bonds, or combinations thereof) of the contaminants inside or on the surface of the filter construction.

The filter construction 10 is designed to reduce contaminants within enclosure 12 by a variety of procedures. A first procedure for reducing, removing, or preventing contamination within enclosure 12 is to reduce or remove any contaminants entering enclosure 12 from regions outside of the enclosure 12 (or other device); a first portion 18 of filter construction 10 is constructed for this purpose. A second procedure for reducing, removing or preventing contamination from within enclosure 12 is to reduce or remove contaminants present in the enclosure atmosphere; a second portion 19 of filter construction 10 is constructed for this purpose.

Hard disk drive enclosure 12 has a port 16 providing fluid communication (i.e., airflow) from the exterior atmosphere into the drive enclosure 12. First filter portion 18 is positioned within or over port 16, so that any air flowing through port 16 into enclosure 12 must encounter first filter portion 18. First filter portion 18 generally includes a particulate or solid contaminant removal element, and also includes a chemical removal element. A “particulate or solid contaminant removal element” is, generally, a high efficiency, high permeability media that removes or at least reduces the amount of solid contaminants passing through or in close proximity to the removal element. A “chemical removal element” is an adsorbent material that either chemically or physically adsorbs or absorbs chemical compounds or molecules. Examples of particulate or solid contaminant removal elements include filter materials such as woven and nonwoven materials, fibers, paper, and the like. Polymeric membranes such as expanded PTFE, polypropylene, and polycarbon can also be used as filter materials. Examples of chemical removal elements include adsorbent elements, adsorbent granules, adsorbent tablets, adsorbent webs, and the like. Additionally or alternatively, a tortuous path, such as a diffusion channel, can be used to reduce the chemical diffusion rate and thereby lower chemical contaminants.

Second filter portion 19 is adapted for reducing contaminants present within enclosure 12. As the disk 14 in enclosure 12 rotates, a stream of air and gases is caused to flow or circulate in the same direction; in FIG. 1, disk 14 is shown rotating counterclockwise and the air flow is represented by the arrows. Second filter portion 19 can also include a chemical removal element, such as an adsorbent element or the like.

The filter construction 10, having first filter portion 18 and second filter portion 19, is positioned within the enclosure 12 at an area with high fluid flow volumes (e.g., high air flow volume). An advantage can be gained by strategic placement of the filter construction 10, specifically the second filter portion 19, across the air stream to provide an optimal filtering effect during operation of the hard disk drive 14; proper placement of the filter construction 10 provides enhanced air clarification by both first and second filter portions 18, 19.

By having both first filter portion 18 and second filter portion 19 in the same construction 10, various advantages are achieved. For example, manufacturing costs are reduced by having a single unit rather than multiple separate units. This decreases the cost associated with manufacturing the unit (one piece versus multiple pieces) and decreases the time and cost associated with assembly of the enclosure 12 because only one unit needs to be placed within enclosure 12. Further, the filtering capabilities of the first and second filter portions 18, 19 can be improved when combined in filter construction 10. Conventionally, first filter portion 18 is usually positioned over a port located directly over hard disk 14. This position is preferred by many because of the low pressure generated by the spinning disk. However, the filter portion 18 is kept to a relatively small thickness in order to allow for proper clearance of the disk as it spins. By placing filter construction 10 to a side or outer edge of disk 14, the shape and size of first filter portion 18 can be designed to improve filtering capabilities. Additionally, there are few size and shape constraints on the shape and size of each of filter construction 10 when it is positioned to a side of disk 14; this allows first filter portion 18 and second filter portion 19 to be optimally designed to achieve high levels of filtering, if desired. For example, greater amounts of adsorbent material can be present in either or both of first filter portion 18 or second filter portion 19. In some embodiments, first filter portion 18 can be located in a low pressure zone of enclosure 12. This would allow maximum airflow from the exterior of enclosure 12 into enclosure 12 through port 16, thus providing maximum filtration of the incoming air stream.

The filter construction 10 is held in the disk drive enclosure 12 by mechanical or adhesive techniques. For example, clips, a frame, or other structures can support filter construction onto surface 15 of enclosure 12. Any supports can be provided around the filter and can be separable from the enclosure. If desired, the filter construction 10 can be welded to the frame or “fitted” in place. Pins can be used to secure filter construction 10 to protrusions on or depressions in surface 15. As another mechanical engagement technique, a portion of the filter construction engages with a structure of enclosure 12; for example, a protrusion on filter construction 10 can be adapted to fit within port 16 in enclosure 12. Double sided tape or other adhesive can be used as an adhesive attachment system, as can a carrier having an adhesive coated onto a surface.

A First Embodiment

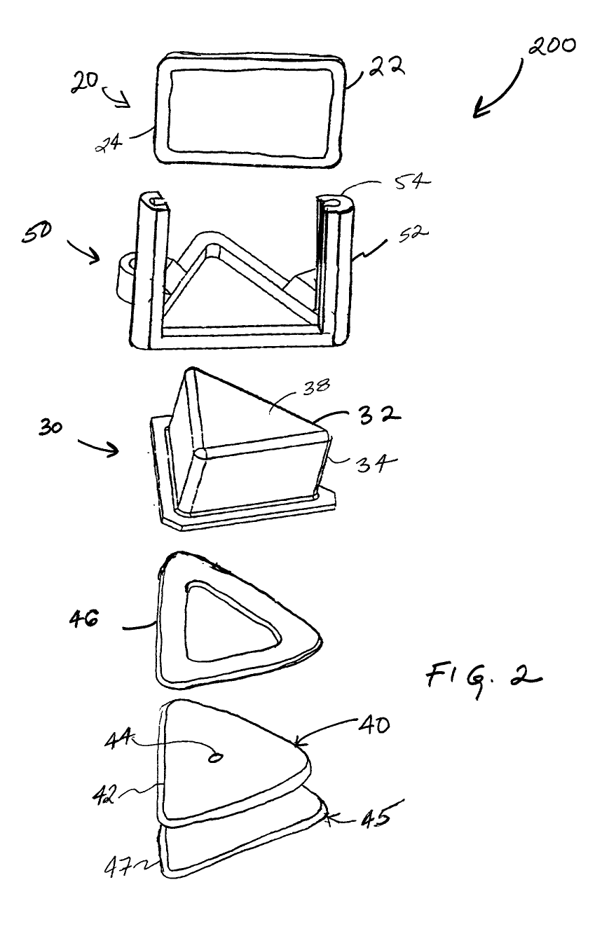

Referring now to FIG. 2, a first embodiment of a filter construction 200 is shown. Filter construction 200 has a first portion adapted to remove or reduce contaminants entering the enclosure in which filter construction 200 is positioned; this first portion includes an adsorbent element 30 and an optional diffusion channel element 40. Filter construction 200 also has a second portion adapted to remove or reduce contaminants present within the enclosure; this second portion includes a recirculation filter 20 with or without an adsorbent element. Overall, filter construction 200 has a recirculation filter 20, a frame 50, an adsorbent element 30, adhesive piece 45, and a diffusion channel element 40. A gasket 46 is included to provide an air tight seal between diffusion channel element 40 and adsorbent element 30.

First Portion for Incoming Contaminants

The various elements of the first portion (depicted as 18 in FIG. 1) will be described. Filter construction 200 has adsorbent element 30 and diffusion channel element 40 that remove or reduce contaminants from the air entering enclosure 12 through port 16 and optionally from air within enclosure 12.

Adsorbent element 30 is configured primarily for the removal of airborne chemical contaminants. The adsorbent element 30 is designed to remove contaminants from the air entering the enclosure by either adsorption (physical or chemical) or absorption. As used throughout this application, the terms “adsorb”, “adsorption”, “adsorbent” and the like, are intended to also include the mechanism of absorption and adsorption. Typically, adsorbent element 30 is selected to be stable and adsorb contaminants within normal disk drive operating temperatures, for example, within a range of about 10° C. to 50° C.

Adsorbent element 30 adsorbs or absorbs one or more types of contaminants, including, for example, water, water vapor, acid gas, and volatile organic compounds. Adsorbent element 30 typically includes a physisorbent and/or chemisorbent material, such as, for example, a desiccant (i.e., a material that adsorbs or absorbs water or water vapor) or a material that adsorbs or absorbs volatile organic compounds, acid gas, or both. Suitable adsorbent materials include, for example, activated carbon, impregnated carbon, activated alumina, molecular sieves, silica gel, and silica. These materials can be combined with or impregnated with, for example, potassium permanganate, calcium carbonate, potassium carbonate, sodium carbonate, calcium sulfate, or mixtures thereof. Although adsorbent element 30 can be a single adsorbent material, mixtures of materials are also useful, for example, silica gel can be blended with carbon particles. In some embodiments, adsorbent element 30 includes layers or combinations of adsorbent material, so that different contaminants are selectively removed as they pass through the different adsorbent materials.

The adsorbent element 30 can be a powder (for example, it passes through 100 mesh) or granular material (28 to 200 mesh). Alternately, adsorbent element 30 can be shaped into a unitary form, such as a granule, bead, or tablet that optionally can be further shaped. In at least some instances, a shaped adsorbent article substantially retains its shape during the normal or expected lifetime of the adsorbent filter assembly 20. The shaped adsorbent article can be formed from a free-flowing particulate material combined with a solid or liquid binder that is then shaped into a non-free-flowing article. The shaped adsorbent article can be formed by, for example, a molding, a compression molding, or an extrusion process.

Preferably the composition of a shaped adsorbent article (i.e., adsorbent element 30) includes at least about 70%, by weight, and typically not more than about 98%, by weight, adsorbent material. In some instances, the shaped adsorbent article includes 85 to 95%, preferably, approximately 90%, by weight, adsorbent material. The shaped adsorbent article typically includes not less than about 2%, by weight, binder and not more than about 30%, by weight, binder. Further information regarding mold release, other additives, and molding techniques are discussed in U.S. patent application Ser. No. 09/353,506, filed Jul. 14, 1999, and in U.S. Pat. Nos. 5,876,487 and 6,146,446, the entire disclosures of which are incorporated herein by reference.

Another embodiment of a suitable adsorbent element 30 includes a carrier. For example, a mesh or scrim can be used as a carrier to hold the adsorbent material and binder. Polyester and other suitable materials can be used as the mesh or scrim. This carrier material can be used as a base on which the adsorbent material is adhered, or the carrier material can be provided on the exterior of a mass of adsorbent material to hold the material together. Typically, any carrier is not more than about 50% of the weight of the adsorbent element, and is more often about 20 to 40% of the total adsorbent weight. The remainder of a shaped adsorbent article is the same or similar to that without the carrier. The amount of binder in the shaped adsorbed article with the carrier typically ranges about 10 to 50% of the total adsorbent weight and the amount of adsorbent material typically ranges about 20 to 60% of the total adsorbent element weight.

Specifically, in one embodiment, adsorbent element 30 of filter construction 200 is a pouch-type element 32. Pouch-type element 32 has an adsorbent material held within a structure 34. Structure 34 can be a molded, cast, or otherwise shaped element. Air permeable membrane 38 allows air flow through structure 34 and through the adsorbent material retained therein; in some embodiments, this air permeable membrane 38 also can have a filtering function, for example, the membrane can be a particulate or solid contaminant removal element. In one embodiment, the air permeable membrane 38 is a polytetrafluoroethylene (PTFE) membrane. In another embodiment, the air permeable membrane 38 is a scrim material. In some adsorbent filters 30, two different air permeable materials can be used; for example, a first surface can have a PTFE membrane and a second surface can have a nonwoven scrim material.

Diffusion channel element 40, of filter construction 10 of FIG. 1 and of filter construction 200 of FIG. 2, provides an extended length of passage compressed into a small space. This tortuous passage can be configured, for example, as an inwardly spiraling channel, an outwardly spiraling channel, or as a maze-like configuration. A diffusion channel provides a plenum that allows air to flow from an inlet to an outlet displaced from the inlet.

Diffusion channel element 40 can be made from a single plastic piece with a tortuous channel carved or molded in the surface thereof. The channel is open to the atmosphere. The molded surface having the channel is then sealed with an impermeable membrane or film, such as mylar, to seal the diffusion channel so that a set number of outlets are present. In anther embodiment, the channel is positioned against another surface, such as surface 15 of disk drive enclosure 12; surface 15 seals the diffusion channel so that the desired number of outlets are present. In yet another embodiment, two plastic pieces may be molded to fit together with a channel therebetween to form diffusion channel element 40. An example of a diffusion channel for use with computer disk drive systems is described in U.S. Pat. No. 4,863,499 (Osendorf). Another example of a suitable diffusion channel element 40, which includes a channel defined by a layer of film, is described in U.S. Pat. No. 5,997,614 (Tuma et al.).

The particular diffusion channel element 40 of filter construction 200 is diffusion channel element 42, which is a single piece of plastic with a tortuous channel molded in the base. An outlet 44, through which air from diffusion channel element 42 passes to adsorbent element 32, extends through the plastic piece. The molded channel intersects port 16 of enclosure 12, preferably at the end of the channel opposite the outlet 44. An adhesive layer 45 is provided to seal the channel and to attach filter construction 200 to the surface 15 of the enclosure 12. The adhesive layer 45 can be an air permeable or impermeable material, but it typically impermeable. The adhesive material can extend across the entire surface of the layer, or only along the periphery. In one embodiment, adhesive layer 45 is a urethane gasket 47 having an adhesive surface.

In some embodiments, no gasket or other sealing layer is used to seal the diffusion channel. Rather, a single piece having a channel therein can be adhered directly to the surface, such as surface 15 of enclosure 12, on which filter construction 200 is positioned.

Second Portion for Already Present Contaminants

It is a preferred embodiment of the present invention that the second filter portion, which removes or reduces contaminants already within the enclosure, has a low pressure drop and provides filtering of particulate, and optionally chemical, contaminants from the environment inside a disk drive. A recirculation filter 20 is a preferred element of the second filter portion.

In one embodiment, the recirculation filter 20 used can be a type of “pillow filter” which is meant to describe its pillowy shape. The edges of the shape are sealed to keep the components of the filter from escaping. As will be apparent from the following description, the recirculation filter 20 of the filter construction can have other structures or shapes, such as, flat tubular, bag-like, etc.

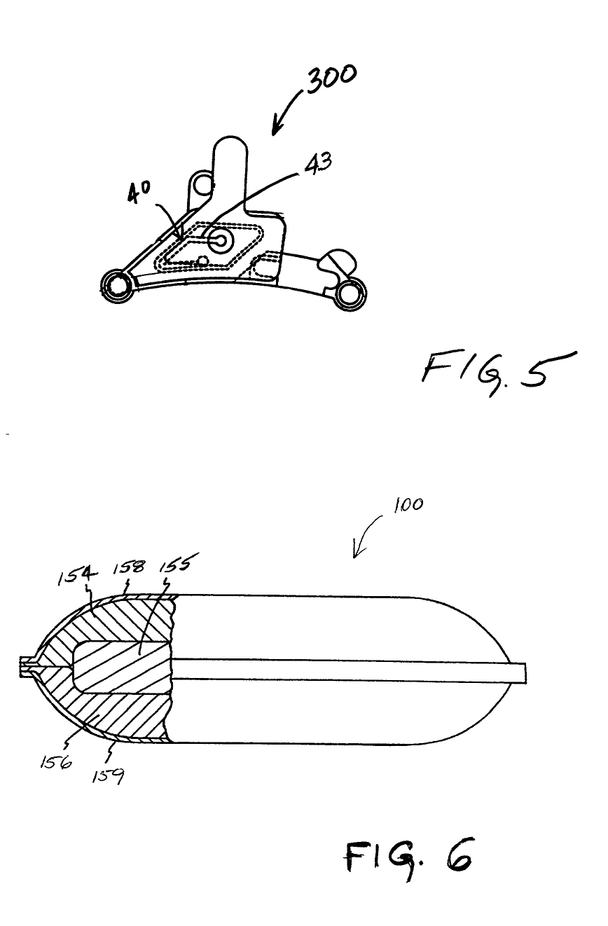

Now referring to FIG. 6, an enlarged partial cross section of a pillow filter 100 is shown. The pillow filter 100 includes a chemical vapor removal layer 155 and particulate removal layers 154, 156. The chemical vapor removal layer 155 can provide permanent removal of certain chemical vapor contaminants, such as acidic or organic gases, and the particulate removal layers 154, 156 can provide permanent removal of certain particulate contaminants. It should be understood that “permanent removal” refers to the removal or entrapment of contaminants which are not released from the filter construction during normal operating conditions for a particular application. In the case of the filter construction 10 which is used inside the hard disk drive enclosure 12, the permanent removal of certain particulate and vapor contaminants from the environment inside the hard disk drive enclosure 12 reflects the fact that those contaminants are not released into the stream of air during normal operating conditions. During conditions which are not normal, for example, when the temperature of the chemical vapor removal layer is heated in excess of normal operating temperatures, vapors may be released from the chemical vapor removal layer. However, these vapors would be again trapped upon return to normal operating conditions.

It should be understood that the chemical vapor removal layer 155 can, if desired, provide some degree of particulate contaminant removal. The particulate removal layers 154, 156, however, generally do not provide for permanent chemical vapor removal. The reason for this is that the materials which make up the particulate removal layers 154, 156 do not physically function to achieve permanent removal of chemical vapor contaminants. Although, chemical vapors may attach to these layers, they can usually become released during the normal operation of the hard disk drive.

The scrim layers 158, 159 are provided to keep the components of the pillow filter 100 from escaping into the environment of the hard disk drive enclosure 12. The scrim layers 158, 159 should have a porosity which is sufficient to minimize pressure drop but, at the same time, contain the components of the pillow filter 100. If, for example, the particulate removal layers 154, 156 are made of a fibrous nonwoven material, the scrim 158, 159 should be sufficient to keep the fibers from escaping. The scrim layers 158, 159 could be omitted from the filter if they are not needed to prevent components of the filter from escaping.

Referring again to FIG. 2, recirculation filter 20 of filter construction 200 is, in one embodiment, a thin pillow, or panel, recirculation filter 22, similar to the recirculation pillow filter 100 of FIG. 6 except that panel recirculation filter 22 is thinner than filter 100.

Filter construction 200 further includes frame 50 that provides support to recirculation filter 20, adsorbent element 30, diffusion channel element 40, and any other elements. Frame 50 provides support or structure to any of the various elements of filter construction. In particular, frame 52 provides support for panel recirculation filter 22, adsorbent element 32, and diffusion channel element 42.

Frame 50 can support the various elements by clips, rails, tines, or any structure that can be used to achieve the desired configuration.

Frame 52 of filter construction 200 retains panel recirculation filter 22 in a desired orientation. Frame 52 preferably is configured to hold filter 22 so that the face having the largest area is presented to the air currents within enclosure 12. In particular, frame 52 includes rails or brackets 54 into which edges 24 of filter 22 slide. With rails 54 holding edges 24 of filter 22, a generally small amount of filter 22 is covered by frame 52, thus increasing the amount of surface area available for filtration. In addition, frame 52 holds adsorbent element 32.

An adhesive ring 46 secures adsorbent element 32 to diffusion channel element 42. This will ensure correct air flow from outlet 44 of diffusion channel element 42 to adsorbent element 32 and minimize leaking around the edges.

Another Embodiment

Referring now to FIGS. 3, 4 and 5, another detailed embodiment of a filter construction 300 is shown; this filter construction includes a recirculation filter 20, an adsorbent element 30, a diffusion element 40, and a frame 50. In particular, filter construction 300 includes recirculation filter 23, adsorbent filter element 33, a particulate filter media 35, a diffusion channel 43, and frame 53.

Filter construction 300 has a portion adapted to remove or reduce contaminants entering the enclosure in which filter construction 300 is positioned; this first portion includes the adsorbent element 33, particulate filter media 35, and diffusion channel 43. Filter construction 300 also has a portion adapted to remove or reduce contaminants present within the enclosure; this second portion includes recirculation filter 23.

Adsorbent element 33, similar to adsorbent element 32 and to general adsorbent element 30, is designed to remove chemical contaminants from the entering air by either adsorption or absorption. Adsorbent filter is a thin, pouch-type element 33 having adsorbent material; by the term “thin”, it is intended that pouch-type element 33 has a thickness that is significantly less than the height or width of the pouch-type element.

Filter construction 300 also includes a diffusion element 40. The particular diffusion element 40 of filter construction 300 is diffusion channel 43, which is molded within the plastic of frame 53. Channel 43 is covered by a double sided adhesive laminate 45, thus forming a thin elongate air passageway.

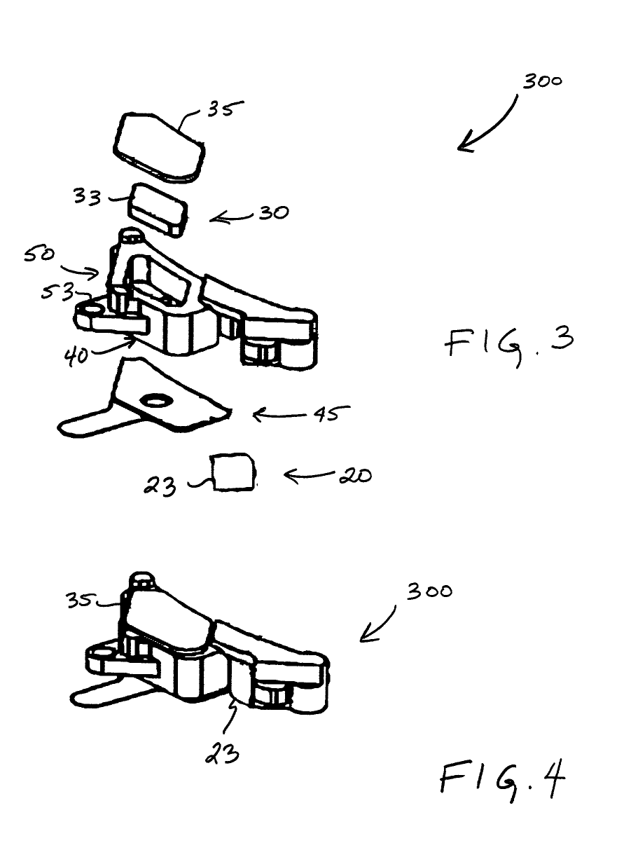

A recirculation filter 20 is included in filter construction 300 to remove or reduce contaminants present in the enclosure atmosphere. Recirculation filter 23 of FIGS. 3 and 4 is a thin planar filter constructed for the removal of both particulate and chemical contaminants.

Filter construction 300 further includes frame 50 that provides support to recirculation filter 20, adsorbent element 30, diffusion element 40, and any other element. In particular, frame 53 holds adsorbent element 33, provides a tortuous path for diffusion channel 43, and supports recirculation filter 23 in an upright orientation.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A filter construction for a disk drive enclosure, the filter construction comprising:
(a) a housing;
(b) a first filter portion in the housing, the first filter portion configured and arranged for positioning in an incoming air stream to provide a path for flow of air into the disk drive enclosure, the incoming air stream entering the disk drive enclosure through a port; and
(c) a second filter portion in the housing, the second filter portion configured and arranged for positioning in an air current to provide a path for flow of air within the disk drive enclosure.

2. The filter construction according to claim 1, wherein the first filter portion comprises:
(a) a particulate filter; and
(b) an adsorbent filter;

3. The filter construction according to claim 2, wherein the first filter portion comprises as diffusion channel.

4. The filter construction according to claim 3, wherein the diffusion channel comprises a plastic piece defining a channel.

5. The filter construction according to claim 4, wherein the channel is positioned against a surface of the disk drive enclosure.

6. The filter construction according to claim 4, wherein at least a portion of the diffusion channel is defined by the housing.

7. The filter construction according to claim 2, wherein the adsorbent filter comprises an adsorbent material selected from the group consisting of activated carbon, impregnated carbon, activated alumina, molecular sieves, silica gel, silica, and combinations thereof.

8. The filter construction according to claim 1, wherein the second filter portion comprises:
(a) an adsorbent filter having a low pressure drop across the adsorbent filter.

9. The filter construction according to claim 8, wherein the adsorbent filter comprises an adsorbent material selected from the group consisting of activated carbon, impregnated carbon, activated alumina, molecular sieves, silica gel, silica, and combinations thereof.

10. The filter construction according to claim 8, wherein the second filter portion comprises a recirculation filter.

11. A disk drive assembly comprising:
(a) an enclosure;
(b) a disk rotatably mounted within the enclosure; and
(c) a filter construction positioned within the enclosure, the filter construction comprising:
(i) a housing positioned in an air current, the air current moving within the disk drive enclosure;
(ii) a first filter portion in the housing; and
(iii) a second filter portion in the housing.

12. The disk drive assembly according to claim 11, wherein the first filter portion is positioned in an incoming air stream, the incoming air stream entering the enclosure through a port.

13. The disk drive assembly according to claim 11, wherein the filter construction is positioned beside the disk.

14. A method of removing contaminants from a disk drive assembly, the method comprising:
(a) positioning a filter construction at least partially within a disk drive assembly, the filter construction comprising:
(i) a first filter portion, and
(ii) a second filter portion;
(b) filtering an incoming air stream with the first filter portion, the incoming air stream entering the disk drive assembly through a port; and
(c) filtering an internal air current with the second filter portion, the internal air current moving within the disk drive assembly.

15. The method according to claim 14, wherein the step of positioning a filter construction at least partially within a disk drive assembly comprises:
(a) positioning a filter construction comprising a first filter portion comprising:
(i) a particulate filter; and
(ii) an adsorbent filter.

16. The method according to claim 14, wherein the step of positioning a filter construction at least partially within a disk drive assembly comprises:
(a) positioning a filter construction comprising a first filter portion comprising a diffusion channel.

17. The method according to claim 14, wherein the step of positioning a filter construction at least partially within a disk drive assembly comprises:
(a) positioning a filter construction comprising a second filter portion comprising:
(i) an adsorbent filter.

18. The method according to claim 14, wherein the step of filtering an internal air current with the second filter portion, the internal air current moving within the disk drive assembly comprises:
(a) filtering an internal air current with the second filter portion, the internal air current circulating within the disk drive assembly.
